(19) United States
(12) Patent Application Publication
(10) Pub. No.: US 2005/0280182 A1
(43) Pub. Date: Dec. 22, 2005

(54) Apparatus and a method for satin-finishing and embossing flat material

(75) Inventor: Charles Boegli, Marin (CH)

Correspondence Address: BACON & THOMAS, PLLC, 625 SLATERS LANE, FOURTH FLOOR, ALEXANDRIA, VA, 22314, US

(73) Assignee: Boegli-Gravures S.A.

(21) Appl. No.: 11/157,984

(22) Filed: Jun. 22, 2005

(30) Foreign Application Priority Data
Jun. 22, 2004 (CH) 02042/04

(51) Int. Cl. B29C 59/04

(52) U.S. Cl. 264/284; 425/363

(57) ABSTRACT

The apparatus for satin-finishing and embossing flat material comprises a first toothed roller and at least a second toothed roller, with the rollers being disposed in such a way that a tooth each of a roller engages between four teeth of the other roller. One of the rollers comprises at least a microstructure and the other roller is provided at the respective place with a counter-pressure surface. The microstructure is applied to a hard surface layer which is applied via an intermediate layer to the roller surface. The method is especially advantageous if a film with a thermoplastic intermediate layer is used. Such an apparatus allows embossing logos with microstructures at all desired locations of the rollers, thus offering a high amount of security against falsification and a large variety of design features.

The present invention relates to an apparatus and a method for satin-finishing and embossing flat material with embossing rollers in accordance with the preamble of claim 1.

Such apparatuses and methods allow satin-finishing the flat material and to provide the same with logos. Flat material may concern so-called inner liners as are used for packaging in the tobacco industry, in foodstuffs such as chocolate, bubblegum, etc. and/or in the pharmaceutical industry. The term “inner liner” comprises all types of films, including aluminum-lined paper, paper or plastic films with applied metal, metallzed films, etc. The flat material shall be referred to as “film” hereinafter for simplicity's sake.

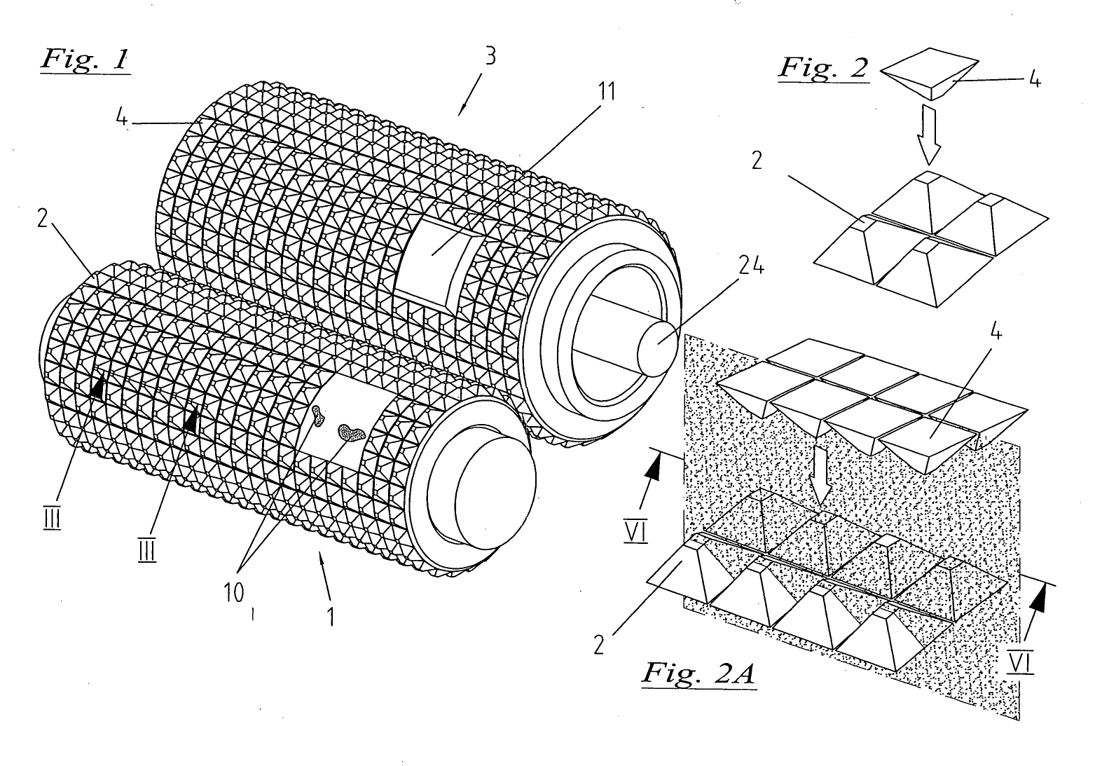

The embossing rollers within the terms of the present invention concern motor-driven embossing rollers with projecting teeth and either at least one counter-roller with similarly raised teeth and/or rollers 3 and 4 according to FIGS. 1 and 2 or 10 and 11 of WO 020/076716 of the same applicant, i.e. rollers with similarly arranged elevated places, which are rings or longitudinal ribs in this case. The respective rollers including their description shall expressly become an integral part of this application.

During satin-finishing, the metallized surface of the film is provided with a regular pattern of sub-millimeter structures, as a result of which it is provided with a silky gloss. Inner tensions in the paper are also compensated, so that any spontaneous rolling together of the film (especially during the packaging process) is prevented.

The term “logo” as used herein shall comprise all marks, decorative elements and/or security features as embossed by embossing rollers.

An apparatus for satin-finishing and embossing is known from WO 02/30661 of the same applicant. In this apparatus, certain teeth are provided with a modified geometry, e.g. they have a reduced depth of the tooth. This allows providing the film which is used among other things as a packaging for tobacco wares and foodstuffs with logos which are used as a security feature and whose appearance will change depending on the observer's angle of view of and on the type and location of the illumination source. The geometrical modifications of the tooth geometry are all within the macro range and are therefore much larger than the wavelength of light, so that its wave characteristic is negligible and the effects as known from geometrical ray optics such as reflection and/or refraction come to bear. Logos that are especially difficult to copy such as hologram-like marks or the like cannot be produced with this apparatus.

The non-published European patent application No. 03405886.7 of the same applicant describes an apparatus for satin-finishing and embossing flat material whose embossing roller (in addition to possible macro-structured teeth with changed geometry) has certain microstructurings which allow producing microstructured logos which are substantially falsification-proof. The microstructurings lie in the region of under one micrometer up to approximately 30 micrometers.

One difficulty in producing such embossing rollers can be their surface properties. In order to provide the same with a predetermined microstructuring, it needs to be especially smooth and free from any coarse-grained structure. It has been noticed that the rollers which are made from steel with the known production methods are unsuitable for applying the desired microstructurings, because a relatively rough and coarse-grained surface structure is obtained as a result of the graininess of the steel which typically lies in the micrometer range.

It was further noticed that the simultaneous embossing of microstructured logos at different places of the film is exceptionally difficult because it is necessary for this purpose to produce a precisely defined, relatively high homogeneous specific embossing pressure at different places.

Based on this state of the art it is the object of the present invention to provide an apparatus and a method for satin-finishing and embossing which allow embossing microstructured logos at any desired location on the film.

An apparatus and a method for achieving this object are given in claim 1 and in the independent method claim. The further claims provide preferred embodiments.

The invention is now explained in closer detail by reference to embodiments shown in the drawings, wherein:

FIG. 1 shows an embossing roller and a counter-roller in a so-called pin-up-pin-up configuration;

FIG. 2 shows a detailed view of FIG. 1 with a tooth of a roller which engages between four teeth of the other roller;

FIG. 2A shows a detailed view of FIG. 1 with eight teeth of a roller which engage between eight teeth of the other roller;

FIG. 3 shows a cross-sectional view along line III-III in FIG. 1 during the mutual engagement of the teeth;

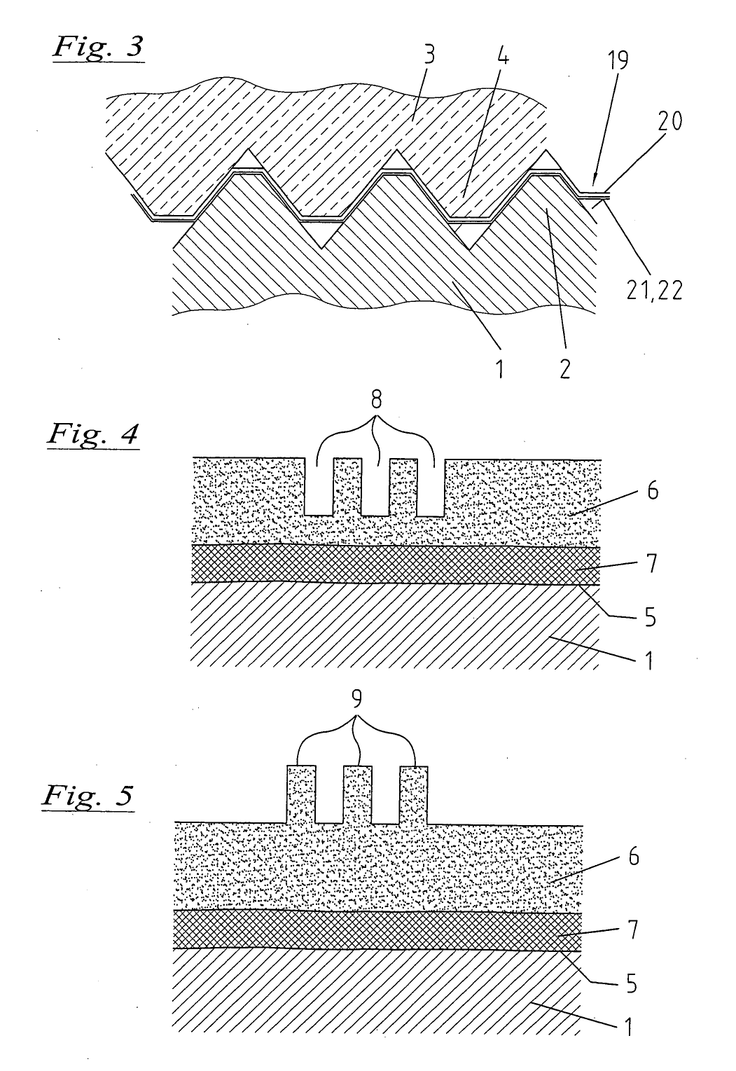

FIG. 4 schematically shows the surface of the embossing roller with a recessed microstructure in a cross-sectional view;

FIG. 5 schematically shows the surface of the embossing roller with an elevated microstructure in a cross-sectional view;

FIG. 6 schematically shows an enlarged section of a sectional view along line VI-VI in FIG. 2;

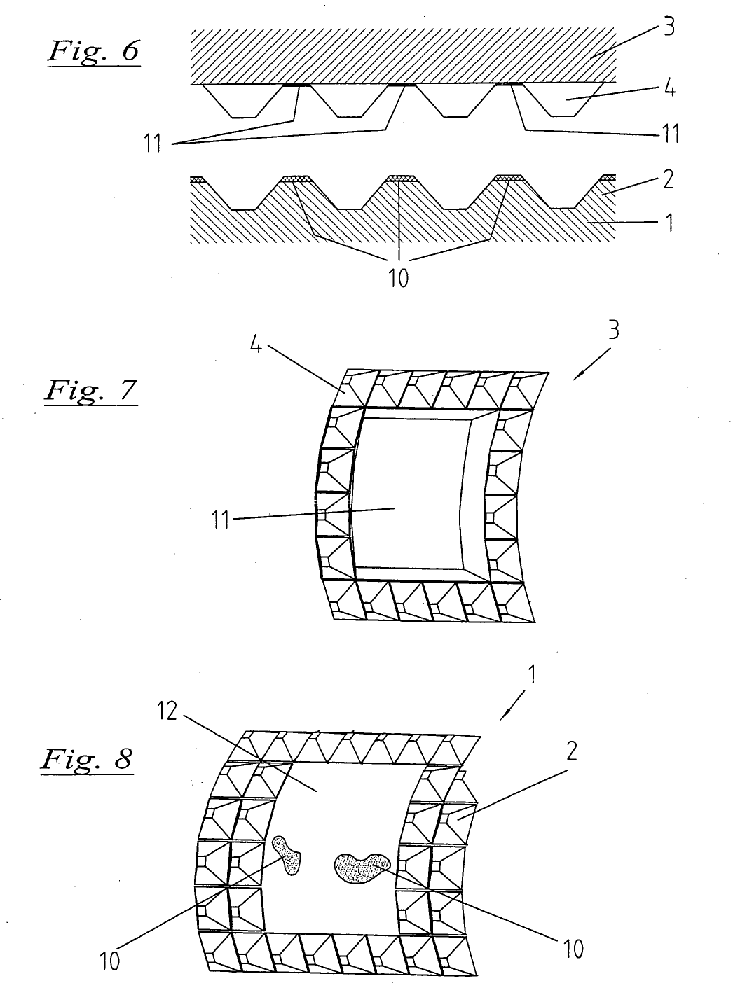

FIG. 7 schematically shows the counter-pressure surface on the counter roller belonging to the section according to FIG. 8;

FIG. 8 schematically shows a second sectional enlargement of the embossing roller of FIG. 1 with microstructures;

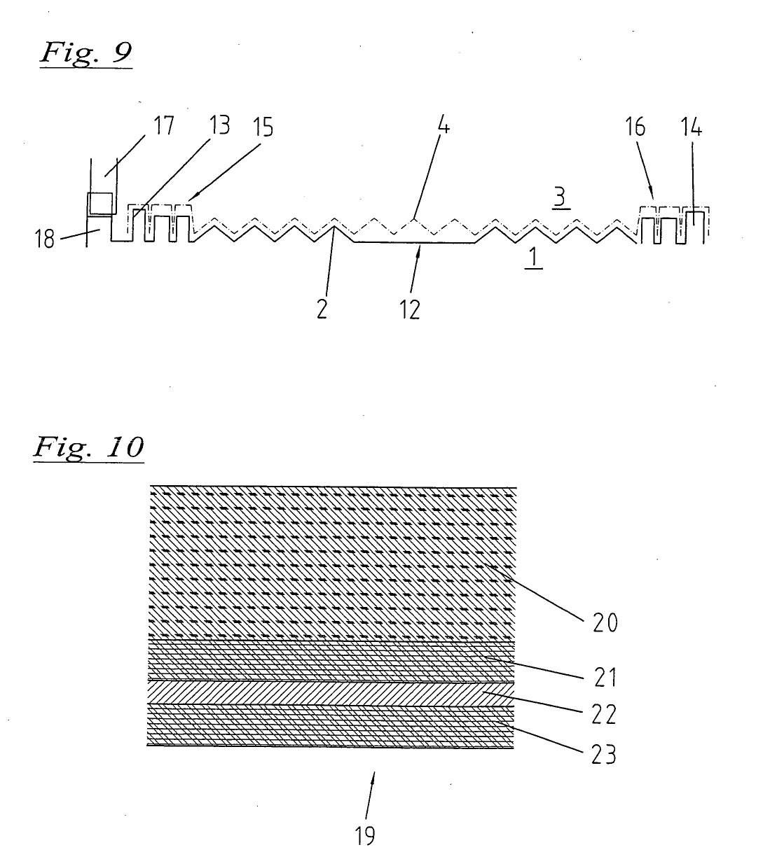

FIG. 9 shows a variant of the two rollers with adjusting and synchronization means, and

FIG. 10 schematically shows a cross-sectional view through a film to be embossed and satin-finished.

FIG. 1 shows an embossing roller 1 and a counter-roller 3 in a so-called pin-up-pin-up configuration, meaning that both rollers are provided with the same protruding teeth 2, 4 which mutually engage for driving the counter-roller and for processing the film according to FIG. 2.

The teeth are provided with a flattened portion and have the shape of a truncated pyramid, as is shown in the illustration. Other tooth geometries are also possible, e.g. in the shape of a truncated cone or semi-spherical. The height of the teeth 2 is typically in the range of approximately 100 to 600 micrometers.

As is also shown in FIG. 2, the rollers are arranged with respect to each other in such a way that a tooth 2 each of the one roller (which in this case is embossing roller 1) engages between four teeth 4 of the other roller (which in this case is counter-roller 3). This arrangement of the teeth can be applied among other things when the embossing roller 1 is driven, whereas the counter-roller 3 runs freely when positioned correctly with respect to roller 1 and is entrained by the teeth or the film by embossing roller 1.

The arrangement of the roller can be similar to that according to EP-B-0 925 911, in which the axis 24 of the counter-roller 3 is arranged so as to be free or deflectable in a guided manner in all three directions of coordinates in order to enable an automatic self-adjustment of the position of the counter-roller with respect to the embossing roller.

FIG. 3 shows the mutual engagement of the teeth 2 and 4, as a result of which the interposed film 19 is processed. This shows that the embossing roller 1 acts upon the metal layer and intermediate coat of lacquer 21, 22 and the counter-roller 3 upon the paper and plastic base 20.

Returning to FIG. 1, a blank region 12 (which is square) is given on the embossing roller 1 where there are no teeth, so that during the passage of the film between the two rollers the metallized region of the film is not satin-finished in the respective region and thus remains glossy. This allows providing the film with a simple logo, especially for decorating purposes. If only such a logo is to be embossed or if no satin-finishing is to be provided in this region, no precautions need to be taken in the counter-roller and it remains unprocessed.

FIG. 1 shows places in the square region 12 of the embossing roller 1 however with predetermined microstructures 6. They are provided with structurings which lie in the range of under 1 micrometer up to approximately 30 micrometers.

They are therefore in the magnitude of the wavelength of light. Microstructured logos can be produced on the film by means of the microstructure which produces optical effects which are linked to the wave nature of the light such as diffraction, interference and/or polarization. Such logos can manifest themselves in the form of colored appearances, holograms or hologram-like patterns, etc. A simple microstructure is a grating for example, as is known from the field of optics. The spaces between the gratings are in the region of under 1 micrometer up to approximately 30 micrometers.

In order to achieve a sufficiently high embossing pressure in the region of the microstructuring, it is necessary to apply respective counter-pressure surfaces 11 on the counter-roller at respective places. These counter-pressure surfaces are shown in FIGS. 1 and 7 as complementary, square counter-pressure surface 11. This counter-pressure surface is usually not structured because it acts upon the paper or plastic side of the film. Should a suitable film be embossed on both sides, the counter-pressure surface can also be structured or microstructured.

For producing the counter-pressure surface it is first necessary to smooth this place, e.g. by means of an ion ray. The method of pulsed laser deposition can then be used for example on this smoothed surface in order to precisely set the thickness of the layer of the counter-pressure surface or its distance to the microstructure.

The blank region 12 with the microstructures 10 and the counter-pressure surface 11 are shown on an enlarged scale in FIGS. 7 and 8.

The microstructures are produced by suitable treatment of the roller surface. As already explained above, the rollers usually have a too rough or grainy surface (especially when they are made of metal) in order to allow them to be structured in the micrometer range. The graininess of steels typically lies in the micrometer range.

To ensure that the roller surface can be provided at the desired places with a predetermined microstructure, the roller surface is smoothed at first at least at such placed (e.g. by means of ion rays) and then an additional homogeneous surface layer is applied which can be microstructured. This is illustrated in a simplified way in FIGS. 4 and 5. The roller surface 5, which prior to the treatment has relatively marked profile caps and valleys at this enlargement factor, is relatively plane after the smoothing process. The surface layer 6 thus also has a relatively plane basic surface which (according to the predetermined microstructure 10) is provided with recesses and elevations.

It was noticed that surface layers of sufficient hardness do not adhere well on steel among other things, so that they can be shorn off even by relatively low forces. As a result it is therefore appropriate to provide an intermediate layer 7 between the surface layer 6 and the actual roller surface 5, which intermediate layer is used as a bonding layer for the surface layer 6. The use of a suitable intermediate layer 7 allows creating a connection between the solid surface layer 6 and the roller surface 5, which connection is characterized by a high adhesive power. The intermediate layer 7 can be of lower hardness than the surface layer 6 and may be composed of several different materials which diffuse into the basic layer.

As is schematically indicated in FIGS. 4 and 5, the recesses are formed by grooves 8 and the elevations by protrusions 9, which are each arranged at a distance of a few micrometers from each other. It is understood that depending on the application other microstructures are also possible, e.g. recesses and/or elevations progressing in a curved way.

The surface layer 6 is hard, i.e. on average it is at least as hard as the roller surface 5, so that the usual service life of the rollers 1, 3 is not reduced. If roller 1 is made of steel as a basic material for example, a material that is at least as hard will be used for the surface layer 6. The hard surface layer 6 guarantees that the microstructure remains undamaged even under a high specific embossing pressure and premature wear and tear of the roller 1 is prevented.

The so-called pulsed laser deposition has proven among others to be suitable for applying the surface layer 6. In this method, the surface 5 to be coated is smoothed, cleaned and activated by ion bombardment in a suitable installation. Then the bonding intermediate layer 7 in the form of a special hexagonal boron nitride phase is produced and then the surface layer 7 in the form of cubic boron nitride (c-BN) by removal of a boron or boron nitride target by means of excimer laser radiation with simultaneous continuous nitrogen or nitrogen/argon bombardment. For further details reference is hereby made to the patent specification DE-A1-198 33 123 for example.

The applied method is characterized among other things by a high growth rate of 60 nm/min, so that the production of microstructured rollers on an industrial scale is possible. The coefficient of friction for c-BN layers lies in the range of 0.1. The Vickers micro hardness as measured at a testing force of 10 Newton (also see DIN 50133) lies in the range of 40 to 45 GPa for c-BN layers. Steel typically has a Vickers micro hardness in the range of 1 GPa.

In addition to c-BN layers, other hard layers such as tungsten or diamond-like carbon layers can also be considered as surface layers (in connection with this please refer to the article as intended for publication in the magazine “Applied Physics A” by Günter Reisse, Steffen Weissmantel and Dirk Rost, “Preparation of super-hard coatings by pulsed laser deposition”).

The person skilled in the art knows other additive methods in addition to pulsed laser deposition. They allow providing the roller surface with a suitable surface layer 6 and, optionally, an intermediate layer 7 for bonding. The aforementioned smoothing of the roller surface is also possible by means of grinding and/or lapping.

If the surface of the rollers consists of another material than steel (e.g. copper or a ceramic coating or the entire roller consists of ceramic), it may optionally not be necessary to provide this surface with a layer and it can then be provided directly with microstructures.

The microstructuring of the surface layer 6 occurs by the application of suitable laser systems for example which work the surface layer in a subtractive way via the masks. The mentioned methods for applying and microstructuring a surface layer offers the possibility to provide the surface of the embossing roller 1 in a purposeful way at the desired places with a predetermined microstructure 10. This does not necessarily need to be the case in a blank region 12.

FIG. 6 shows an example which shows an enlarged sectional view along line VI-VI in FIG. 2A. The cross-sectional plane in FIG. 6 extends in the longitudinal direction of the embossing roller 1 through the tips of the teeth, as is indicated in FIG. 2A by the arrows VI-VI. The tips of the teeth are opposed, according to the pin-up-pin-up configuration as shown in FIG. 2A, by the region between the teeth of the counter-roller 3, i.e. the tooth base, which is shown in FIG. 6 by a plane profile, with the teeth being visible behind the cutting plane. FIG. 6 shows several adjacent tooth tips of the embossing roller 1 with a microstructure 10.

Based on these few examples, a plurality of microstructures and optionally macrostructures can be applied to the embossing roller 1, leading to a respectively large variety of patterns on the film. The embossing roller 1 can be provided with a predetermined microstructure over large surface areas or in a locally limited fashion.

FIG. 8 shows the blank region 12 (which is square) of the embossing roller 1 which is provided with two microstructures 10. In order to enable the generation of the necessary embossing pressure for the microstructures on the film, a counter-pressure surface is principally required at each of the places of the counter-roller 3 which correspond to the microstructures 10. When there is a blank region in which the microstructures are applied, it is necessary to use a similar region as a counter-pressure surface on the counter-roller. In that case it does not play any role how many microstructures are present in the blank region.

FIG. 7 therefore shows a counter-pressure surface 11 in the form of the blank region 12 of roller 1 which applies to both microstructures 10. This ensures that the distance between the microstructure and the counter-pressure surface is sufficiently small in order to enable the generation of the required embossing pressure.

Whereas usually the embossing roller is machined in order to emboss a logo which can also be microstructured and the counter-roller only comprises counter-pressure surfaces which correspond to the microstructures, the microstructures can also be present on the counter-roller and the counter-roller surfaces can be on the embossing roller.

In order to ensure among other things that the counter-pressure surfaces 11 are located at the correct places in the axial and radial direction, adjusting means are attached to the rollers 1, 3, e.g. in the form of adjusting rings and adjusting teeth. The adjusting means allow adjusting the relative position of the two rollers 1, 3 relative to each other precisely during the mounting. Moreover, the two rollers 1, 3 can be positively synchronized, e.g. by means of gearwheels or other synchronization means such as electronic components and the like.

FIG. 9 shows in a simplified lateral projection the two rollers 1 and 3 whose teeth 2 and 4 are in engagement. The rollers 1, 3 are provided at the end side with an adjusting ring 13, 14 and with adjusting teeth 15, 16 which are coarser than the other teeth 2, 4 and are positively synchronized by means of the gearwheels 17 and 18. It is also possible to use only individual adjusting means.

As already mentioned, the embossing apparatus can have more than one counter-roller, e.g. according to WO 02/076716 it can have two teethed counter-rollers or one or several counter-rollers with rings or one or several counter-rollers with longitudinal ribs.

An especially advantageous method for satin-finishing and embossing especially microstructured logos is obtained when the film 19 comprises at least one thermoplastic layer, e.g. an intermediate lacquer layer, so that the layer becomes deformable by heating. A film is used for example in the packaging industry as is shown in a cross section of FIG. 10 which is not true to scale. FIG. 19 comprises a paper fiber structure 20 with a thickness of 10 to 100 micrometers whose surface is provided with an intermediate lacquer layer 21 of a thickness of 1 to 5 micrometers. A fine layer 22 of metal (e.g. aluminum) of a thickness of a few 15 to 20 nm is metallized, which layer per se is protected by an also very fine cover lacquer layer 23.

If embossing on both sides of the film is desired, the film can comprise an intermediate lacquer layer on both sides of the paper.

The local embossing pressure required for producing the micro-embossing can be lowered substantially by heating the film to a temperature which lies typically in a range of between 70° C. and 120° C. The embossing is thus substantially only introduced into the intermediate lacquer layer and not into the entire film.

Since the metal layer 22 is very thin, the optical effects produced by the micro-embossing can easily be seen by the eye.

The film is heated for example by holding the embossing roller 1 and/or the counter roller 3 and/or the region of the microstructure to a respective heating temperature by means of heating means. It is also possible to heat the film before it is passed through the rollers 1 and 3. For the purpose of softening a suitable thermoplastic or intermediate lacquer layer, a suitable radiation source such as a UV radiation source can be used.

In a further variant, the heating means can be chosen in such a way that the region of the microstructure(s) can be brought in a purposeful manner to heating temperature or normal temperature. This allows virtually activating or deactivating the microstructure(s), so that the film is provided at the respective location either with a micro-embossing or is left unchanged. An infrared laser in combination with a glass fiber bundle and/or a suitable optical system can be used as a heating means in order to supply energy locally.

The apparatuses and methods in accordance with the invention lead to the following advantages and maintain known favorable properties:
Rollers which have a rough surface structure (especially such made of steel or ceramics) can be provided with microstructures directly by means of embossing.
Films usually used in the packaging industry can be processed, among other things.
Films with a layer which are deformable when heated can be embossed at a lower embossing pressure. Precise micro-embossing can be produced in metallized inner liners. Furthermore, wear and tear of the rollers is reduced as a result of the lower embossing pressure.
The films can be embossed at different places with marks whose appearance will change depending on the angle of view of the spectator and/or the type and/or the location of the illumination source, especially diffractive color effects or hologram-like marks. This offers a high amount of security against falsification because locally engraved microeffects can hardly be emulated or only with much difficulty, especially in cases when several microstructures are used in order to provide the film at different locations with microstructured logos. In combination with other known embossing methods such as the so-called shadow embossing, a film can be provided with security features which are similar to those of banknotes.

1-14. (canceled)

15. An apparatus for satin-finishing and embossing films having:
a first roller with elevated teeth; and
at least one second roller with elevated teeth, elevated rings or elevated longitudinal ribs, wherein:
at least one of the rollers comprises at least one microstructure and at least one of the other rollers is provided with a counter-pressure surface at the location corresponding to the microstructure.

16. The apparatus according to claim 15, wherein:
said microstructure is applied to a suitable smoothed surface layer.

17. The apparatus according to claim 15, wherein:
an intermediate layer is applied as a bonding layer between said smoothed surface layer with said microstructure and the roller surface, and
said smoothed surface layer is at least as hard as the roller surface.

18. The apparatus according to claim 16, wherein:
the first roller comprises a tooth-free region in which said smoothed surface layer with said microstructure is arranged.

19. The apparatus according to claim 17, wherein:
said smoothed surface layer and/or said intermediate layer and/or the counter-pressure surface is produced by pulsed laser deposition and preferably contain boron nitride.

20. The apparatus according to claim 15, wherein:
the rollers contain adjusting means and/or synchronization means.

21. The apparatus according to claim 15, wherein:
the roller with said at least one microstructure is the embossing roller connected with a drive and the at least one counter-pressure surface is disposed on the free-running counter-roller.

22. The apparatus according to claim 21, wherein:
the rollers can be pressed against each other in a resilient manner and the axis of the counter-roller can be deflected in all three directions of space coordinates.

23. The apparatus according to claim 15, wherein:
it comprises a radiation and/or heat source acting upon the film.

24. The apparatus according to claim 15, wherein:
the flat material to be processed is a film which comprises an intermediate lacquer layer applied onto a basic layer made of paper or plastic material and a metal layer applied onto the same.

25. The apparatus according to claim 24, wherein:
said film further comprises a lacquer cover layer.

26. A method for satin-finishing and embossing a film having an intermediate lacquer layer applied onto a basic layer made of paper or plastic material and a metal layer, comprising the step of:
softening the intermediate lacquer, at least in the region which is embossed by the microstructure.

27. The method according to claim 26, wherein:
the roller provided with the microstructure and/or the film, before it is guided between the rollers, is heated.

28. The method for satin-finishing and embossing a film with an apparatus according to claim 26, wherein:
the film is embossed on both sides.
